(19) United States
(12) Patent Application Publication
(10) Pub. No.: US 2018/0070523 A1
(43) Pub. Date: Mar. 15, 2018

(54) Soil processing attachment for a tractor

(71) Applicants: Randall Prince, Humboldt, TN (US); Bradley Mayer Hayes, Jackson, TN (US); Joshua Michael Hayes, Jackson, TN (US)

(72) Inventors: Randall Prince, Humboldt, TN (US); Bradley Mayer Hayes, Jackson, TN (US); Joshua Michael Hayes, Jackson, TN (US)

(21) Appl. No.: 15/700,628

(22) Filed: Sep. 11, 2017

Related U.S. Application Data
(60) Provisional application No. 62/394,109, filed on Sep. 13, 2016.

(51) Int. Cl. A01B 49/02; A01B 79/00; A01B 59/06; A01B 63/102; A01B 63/111; A01B 3/36; A01B 19/02; A01B 27/00

(52) U.S. Cl. CPC A01B 49/027; A01B 79/00; A01B 59/066; A01B 27/005; A01B 63/111; A01B 3/36; A01B 19/02; A01B 63/102

(57) ABSTRACT

An attachment for a tractor including a frame with a forward portion and a rear portion, the rear portion pivotally connected to the forward portion; and two or more shanks attached to the forward portion.

A method of operating an attachment for a tractor including connecting an attachment to a tractor, the attachment including a frame and two or more shanks, the frame including a forward portion and a rear portion, the shanks being attached to the forward portion and pivoting the rear portion of the frame relative to the forward portion of the frame.

### CROSS-REFERENCE TO RELATED APPLICATIONS

This application claims priority to U.S. Provisional Application No. 62/394,109; filed Sep. 13, 2016; titled “A soil conditioning and leveling attachment used in the equine, hunting/agriculture and construction/landscaping industries, ” which is hereby fully incorporated into this patent application by reference.

### STATEMENT REGARDING FEDERALLY SPONSORED RESEARCH OR DEVELOPMENT

None.

### REFERENCE TO A MICROFICHE APPENDIX

None.

### FIELD OF THE INVENTION

The invention, relates generally to an attachment for breaking-up, conditioning, and/OR leveling soil for use in the equine industry, farming and hunting industry, or landscaping and construction industry.

### BACKGROUND OF THE INVENTION

Various tractor attachments for processing soil exist. The attachments are generally pulled behind the tractor and include one or more tools for breaking-up, conditioning, and/or leveling the soil. Existing attachments, however, are incapable of quickly processing a wide range of soil types to a sufficient degree. Moreover, many existing attachments “load up” with dirt, which is undesirable.

The processing of soil through breaking-up, conditioning, and/or leveling the soil is useful in various industries including the equine industry, farming and hunting industry, and landscaping and construction industry. Processing of soil in the equine industry is important to ensure the safety and performance of animals. Processing of soil in the farming and hunting industry is important to increase yields and decrease the costs of farming. Processing of soil also increases efficiencies in the landscaping and construction industries.

### BRIEF SUMMARY OF THE INVENTION

In various exemplary embodiments, the attachment for a tractor comprises a frame with a forward portion and a rear portion, the rear portion pivotally connected to the forward portion; and two or more shanks attached to the forward portion.

In various exemplary embodiments, the method of operating an attachment for a tractor comprises connecting an attachment to a tractor, the attachment comprising a frame and two or more shanks, the frame comprising a forward portion and a rear portion, the shanks being attached to the forward portion; and pivoting the rear portion of the frame relative to the forward portion of the frame.

### BRIEF DESCRIPTION OF THE SEVERAL VIEWS OF THE DRAWINGS

FIG. 1 shows a first side view of a first embodiment of the invention.

FIG. 2 shows a second side view of the first embodiment of the invention

FIG. 3 shows a first side view of a second embodiment of the invention.

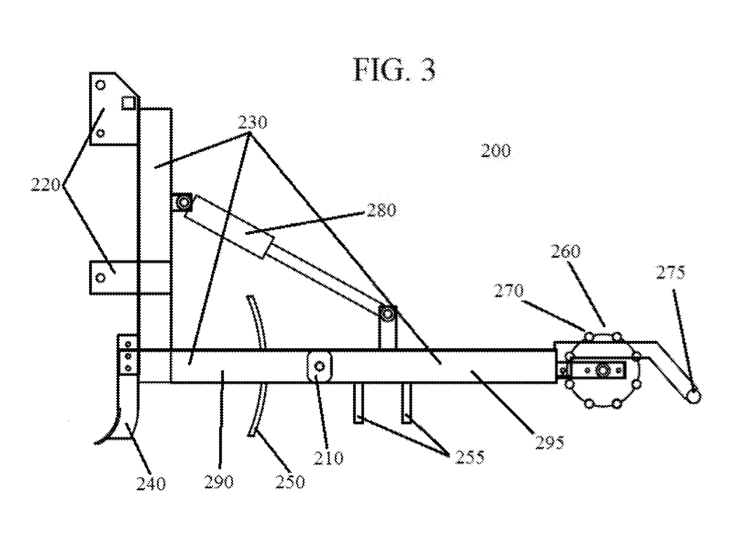

FIG. 4 shows a first top view of the second embodiment of the invention.

### DETAILED DESCRIPTION OF AN EMBODIMENT OF THE INVENTION

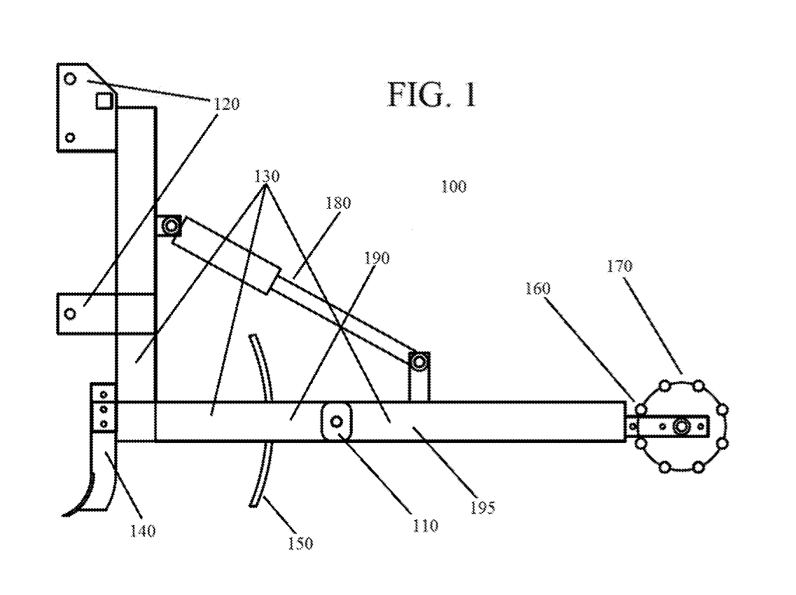

FIG. 1 shows a first side view of a first embodiment of the present invention. In this embodiment, attachment 100 includes a frame 130. In this embodiment, the frame is a heavy-duty frame welded and assembled from either custom machined or purchased parts. Attachment 100 includes a 3-point hitch 120 for attaching attachment 100 to a tractor. As will be understood by one of ordinary skill in the art, frame 130 and 3-point hitch 120 can be designed to work with many makes and models of tractors ranging in horsepower.

Attached to frame 130 are a series of ripper shanks 140 and a series of curved tines 150, which in this embodiment are high carbon and durable. In this embodiment, ripper shanks 140 can be raised or lowered relative to forward portion 190 of frame 130 to adjust the depth at which ripper shanks 140 break-up and turnover soil. In this embodiment, attachment 100 also includes a rotating wheel 170 that includes a plurality of chopping tools 160. In alternative embodiments, attachment 100 may include a cylinder packer to pack and/or level soil.

Attachment 100 includes a hydraulic cylinder 180 for pivoting rear portion 195 with respect to forward portion 190. In this embodiment, rear portion 195 is pivoted about a pivot joint 110. In alternative embodiments, a manual adjustable link is used as an alternative to the hydraulic cylinder 180. By pivoting rear portion 195, the operator of attachment 100 can control the depth of ripper shanks 140 on forward portion 190 during use of attachment 100. In this embodiment and this figure, rear portion 195 is pivoted downward such that rotating wheel 1.70 contacts the ground, which during use of attachment 100, limits the depth at which ripper shanks 140 on forward portion 190 penetrate the ground.

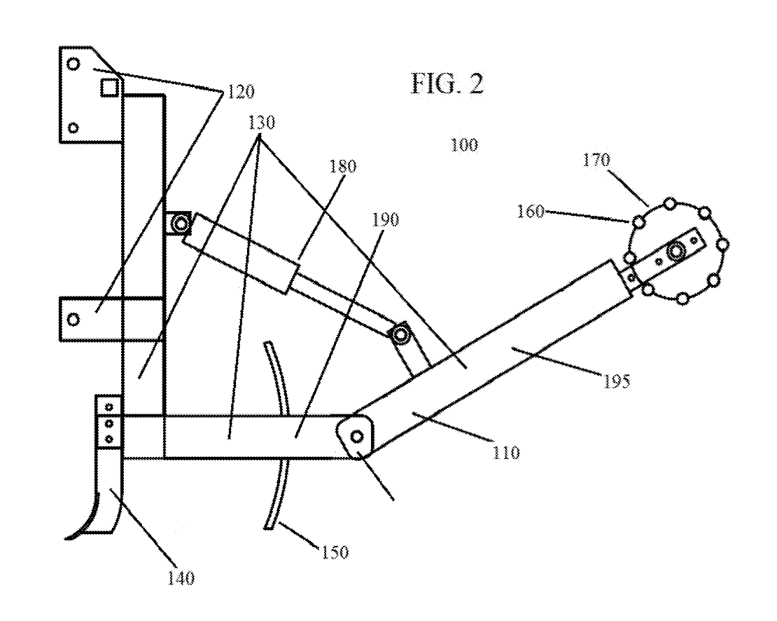

FIG. 2 shows a second side view of the first embodiment of the present invention. In this figure, rear portion 195 is pivoted upward, which does not limit the depth at which ripper shanks 140 on forward portion 190 penetrate the ground.

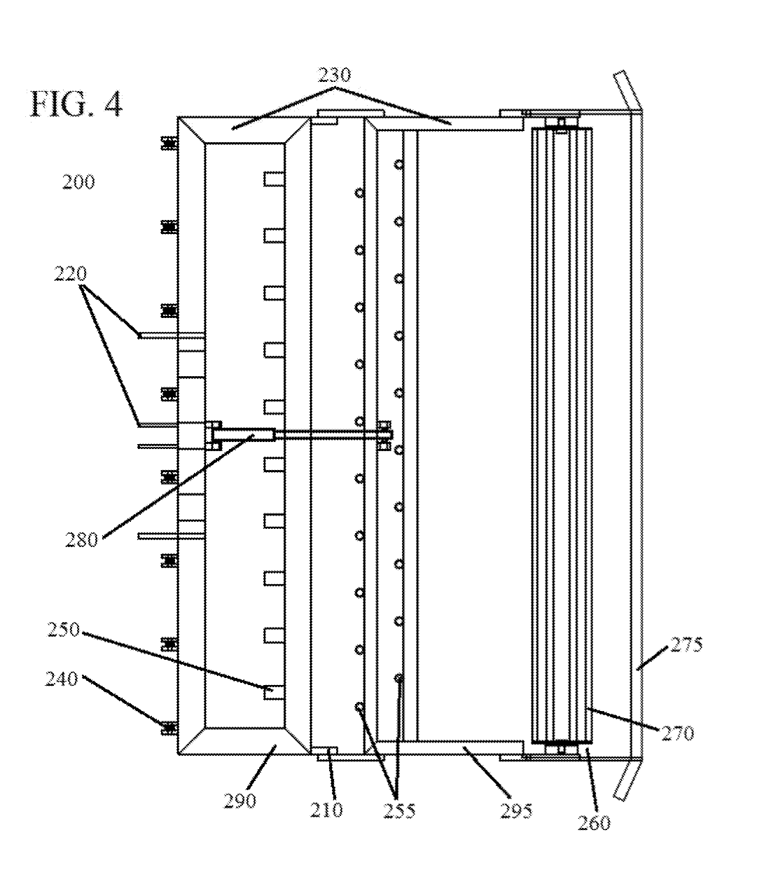

FIG, 3 shows a side view of a second embodiment of the present invention. FIG. 4 shows a top view of the second embodiment of the present invention, In the second embodiment, attachment 200 includes a. frame 230. Frame 230 includes a forward portion 290 and a rear portion 295, Attachment 200 also includes a 3-point hitch 220 for attaching attachment 200 to a tractor.

Attached to frame 230 are a series of ripper shanks 240, a series of curved tines 250, and two series of harrow teeth 255. In this embodiment, the series of ripper shanks 240 and series of curved tines 250 are located on forward portion 290 of attachment 200, and the two sets of harrow teeth are located on rear portion 295 of attachment 200. In this embodiment, attachment 200 also includes a rotating wheel 260 that includes a plurality of chopping tools 270, and a leveler 275.

Attachment 200 includes a hydraulic cylinder 280 for pivoting rear portion 295 relative to forward portion 290 of the attachment 100. In this embodiment, rear portion 295 is pivoted about a pivot joint 210. By pivoting rear portion 295, the operator of attachment 200 can control the depth of ripper shanks 240 and high carbon tines 250 on forward portion 290 during use of attachment 200.

The above descriptions of embodiments of the present invention are not intended to, arid shall not be construed to, limit the scope of the claims. The embodiment is just that—an embodiment, and is not meant to describe every possible configuration of the present invention.

1. An attachment for a tractor, comprising:
a frame with a forward portion and a rear portion, the rear portion pivotally connected to the forward portion; and
two or more shanks attached to the forward portion.

2. The attachment of claim 1, further comprising a top link adapted to pivot the rear portion relative to the forward portion.

3. The attachment of claim 1, further comprising a hydraulic pump adapted to pivot the rear portion relative to the forward portion.

4. The attachment of claim 3, further comprising a rotating soil refinement tool attached to the rear portion.

5. The attachment of claim 4, wherein the position of the shanks are adjustable with respect to the forward portion.

6. The attachment of claim 4, further comprising two or more curved tines attached to the frame.

7. The attachment of claim 6, further comprising two or more harrow teeth attached to the frame.

8. The attachment of claim 7, further comprising a packing cylinder attached to the frame.

9. The attachment of claim 8, further comprising a leveler attached to the frame,

10. The attachment of claim 4, wherein the rotating soil refinement tool is adapted to limit a penetration depth of the shanks.

11. The attachment of claim 10, wherein pivoting the rear portion downward reduces the penetration depth of the shanks.

12. A method of operating an attachment for a tractor, comprising:
connecting an attachment to a tractor, the attachment comprising a frame and two or more shanks, the frame comprising a forward portion and a rear portion, the shanks being attached to the forward portion; and
pivoting the rear portion of the frame relative to the forward portion of the frame.

13. The method of claim 12, wherein the rear portion of the frame is pivoted with a manual link.

14. The method of claim 12, wherein the rear portion of the frame is pivoted with a hydraulic cylinder.

15. The method of claim 14, wherein a rotating soil refinement tool is attached to the rear portion.

16. The method of claim 15, further comprising the step of:
adjusting the position of the shanks relative to the forward portion of the frame before the rear portion of the frame is pivoted.

17. The method of claim 15, wherein the rear portion of the frame is pivoted downward relative to the forward portion of the frame.

18. The method of claim 17, wherein pivoting the rear portion downward moves the rotating soil refinement tool downward.

19. The method of claim 18, wherein the rotating soil refinement tool limits a penetration depth of the shanks.

20. The method of claim 19, wherein 2 or more curved tines are attached to the frame.
